(19) United States
(12) Patent Application Publication
(10) Pub. No.: US 2006/0273728 A1
(43) Pub. Date: Dec. 7, 2006

(54) High-pressure gas discharge lamp

(75) Inventors: Matthias Born, Geldern (DE); Ulrich Niemann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electrnics N.V., Eindhoven (NL)

(21) Appl. No.: 10/570,534

(22) PCT Filed: Sep. 1, 2004
(86) PCT No.: PCT/IB04/51657

§ 371 Date: Mar. 3, 2006

(30) Foreign Application Priority Data
Sep. 11, 2003 (EP) 031033517

(51) Int. Cl. H01J 61/18; H01J 17/20

(52) U.S. Cl. 313/638

(57) ABSTRACT

A high-pressure gas discharge (HID, high intensity discharge) lamp is described, having a discharge vessel (1) that contains a metal that is applied at least to parts of those regions of the feedthroughs and/or walls of the discharge vessel (1) at which condensation of ingredients of the gas filling may occur as a result of a temperature sink that occurs when the lamp is in a state of operation. In this way, it is possible to at least largely prevent not only chemical interactions between ingredients of the gas filling (particularly the metal halides) and the relevant regions of the feedthroughs or walls at which, due to the lower temperature of these regions, the ingredients condense, but also losses of ingredients of this kind from the gas filling. This in turn means that there is no risk of any damage to the lamp or of any degradation of its lumen maintenance.

### DESCRIPTION

The invention relates to a high-pressure gas discharge (HID, high intensity discharge) lamp having a discharge chamber for a gas filling.

Due to their good lighting properties, high-pressure gas discharge lamps have become widely used. They generally comprise a discharge vessel having feedthroughs through which electrodes extend into the discharge vessel, or rather into the discharge chamber enclosed by the latter. When the lamp is in the operating state, an arc discharge is excited between the opposing free ends of the electrodes.

The discharge chamber generally contains a gas filling (lamp filling) comprising a starter gas (such as argon for example), a discharge gas (such as one or more metal halides such as sodium iodide and/or scandium iodide for example), which forms the actual light-emitting material (light producer), and a voltage-gradient generator or buffer gas (such as mercury) whose principal function is to promote the evaporation of the light-producing substances by raising the temperature or pressure, and to increase the efficacy and burning voltage of the lamp.

For the electrodes to be accurately and permanently positioned with a gas-tight seal, the standard of the feedthroughs needs to meet stringent requirements. To enable these requirements to be met, both the material of which the feedthroughs are made (such as quartz or polycrystalline Al₂O₃ [PCA]) and the material of the electrodes (such as tungsten, molybdenum, niobium for example) are of particular importance.

In the case of the CDM lamps made from PCA, the electrodes, which are manufactured from tungsten, molybdenum or niobium (the latter is used to match the coefficient of expansion of the electrode to that of the wall material), are for example fixed in the associated feedthrough with a seal by means of a so-called fused glass, comprising a mixture of high-temperature oxides such as, for example, Al₂O₃, Dy₂O₃ and SiO₂ (“AlDySi”).

A problem that often exists in this case is that the metal halides contained in the gas filling react with the electrodes and/or the fused glass and sometimes penetrate into the feedthroughs and cause leaks in them.

To minimize chemical interactions of this kind, various measures are adopted to attempt to keep the feedthroughs at a temperature that is as low as possible. However, because the metal halides that are present in a gaseous state in the gas filling have the property of migrating towards temperature sinks of this kind, and then of at least partly condensing there, they are lost to the discharge gas while the lamp is working and are no longer available for their true purpose, namely to increase the particle concentration and the light emission in the plasma.

Something else that is observed is that, even when steps of this and other kinds are taken, the possibility still cannot be entirely ruled out, when high intensity discharge lamps are in use for long periods, of chemical interactions taking place between the electrodes and ingredients of the gas filling, particularly in the region of the feedthroughs, and of unwanted effects thus occurring. In the case of lamp envelopes made of quartz glass, interactions of this kind take place particularly at the fused seals of the electrodes, and in the case of PCA lamps in the fused glass used for sealing purposes.

These interactions or unwanted effects are in particular transport processes involving ingredients of the gas filling and also, in cases where quartz glass is used in the wall of the discharge vessel, recrystallization of the quartz. The effects may cause a clouding of the discharge vessel, shifts in the color temperature of the light emitted, and a more marked degradation of the lumen maintenance of the lamp.

It is therefore an object of the invention to provide a high-pressure gas discharge lamp in which the chemical interactions between ingredients of the gas filling and the electrodes, the inner wall of the discharge chamber and the feedthroughs are at least substantially reduced.

The aim is also to provide a high-pressure gas discharge lamp in which the loss of ingredients from the gas filling, due in particular to transport processes connected with temperature sinks and/or to condensation, is at least substantially lower while the lamp is operating.

In accordance with claim 1, the object is achieved by a high-pressure gas discharge lamp having a discharge vessel containing a metal that is applied at least to parts of those regions of the feedthroughs and/or walls of the discharge vessel at which condensation of ingredients of the gas filling may occur due, in particular, to temperature sinks that occur when the lamp is in a state of operation.

One advantage of this solution is that it renders it possible at least to minimize not only said chemical interactions between ingredients of the gas filling and the regions of the feedthroughs and/or wall at which the ingredients condense, due in particular to the lower temperature of these regions, but also losses of ingredients of this kind from the gas filling. In this way, any risk either of the lamp being damaged or of its lumen maintenance being degraded can be avoided to a considerable degree.

The dependent claims relate to advantageous embodiments of the invention.

The embodiment to which claim 2 relates has the advantage that the metal can be applied to said regions relatively easily, for example, by producing a temperature sink in said regions by heating and/or cooling the lamp before the lamp is put into operation for the first time, on which regions the metal will then deposit.

The embodiments to which claims 3 and 4 relate reduce in particular the transport of electrode material which may cause the wall of the discharge lamp to become darkened.

The embodiment to which claim 5 relates prevents in particular chemical interactions between the gas filling and a fused glass used for sealing purposes.

The metal that is introduced in accordance with the invention may also itself be used for sealing purposes, as claimed in claim 6, or, as claimed in claim 7, may correct flaws in the wall of the discharge vessel and/or of the feedthrough (particularly what are called shrink holes).

Claim 8 gives examples of the metals according to the invention.

Finally, claim 9 deals with a preferred method by which the metal can be applied to said regions in a particularly simple and effective manner.

These and other aspects of the invention are apparent from and will be elucidated with reference to the embodiments described hereinafter.

In the drawings:

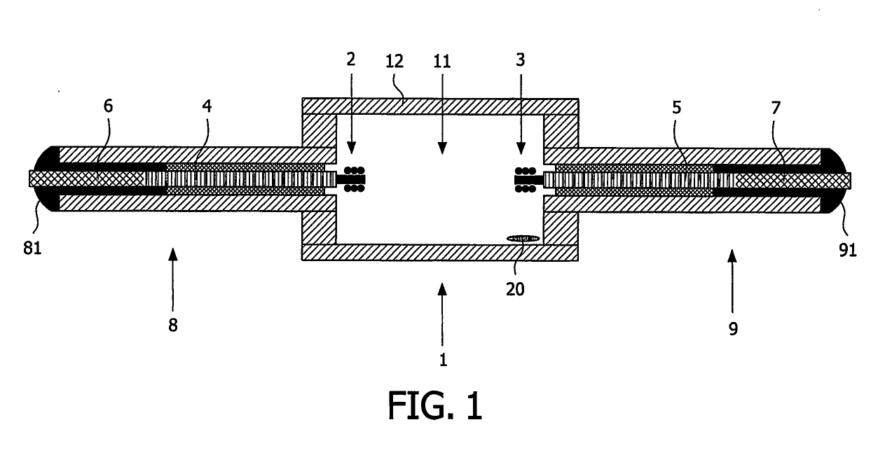

FIG. 1 is a diagrammatic longitudinal section through a high-pressure gas discharge lamp according to the invention.

The invention will be described below with reference to a CDM lamp having a PCA wall material. The invention may, however, be applied to all other types of high-pressure gas discharge lamps, in which case the sealing materials according to the invention may vary as a function of the wall material and the nature and design of the feedthroughs.

FIG. 1 is a diagrammatic view of a high-pressure gas discharge lamp of this kind. The lamp comprises a discharge vessel 1 which encloses a discharge chamber 11. The wall 12 of the discharge vessel 1 is made of polycrystalline Al₂O₃ (PCA).

Extending into the discharge chamber 11 from opposite ends thereof are the free first ends 2, 3 of electrodes, which electrodes are made of a material, such as tungsten, having a melting point that is as high as possible. The other ends of the electrodes are in contact with respective electrically conductive ribbons (or foils) 4, 5, made in particular of molybdenum or cermet, the ribbons 4, 5 being connected in turn to respective terminal pins 6, 7 made of, for example, niobium. The free ends of the terminal pins 6, 7 finally form the external electrical contacts of the discharge lamp.

To ensure a vacuum-tight entry for the electrodes into the discharge chamber 11, the discharge vessel 1 is provided with two feedthroughs 8, 9 (pinches) that have embedded in them respective ones of the electrodes, respective electrically conductive foils 4, 5, and portions of respective terminal pins 6, 7. At their outer ends, the feedthroughs 8, 9 are sealed off with seals 81, 91 made of fused glass. Typical components of this fused glass are varying proportions of Al₂O₃, Ln₂O₃ (Ln=a rare earth metal), and SiO₂.

When the lamp is in the operating state, an arc discharge (a light-generating arc) is excited between the first (free) ends 2, 3 of the electrodes.

For this purpose, the discharge chamber 11 is filled with a gas which comprises not only a starter gas, such as argon for example, but also a discharge gas (light producer) which emits light radiation as a result of excitation or discharge and, preferably, a voltage-gradient generator or buffer gas, both of which latter gases may be selected from the group of metal halides.

The light-producing substances are in particular mixtures of different metal halides such as NaI, DyI₃, HoI₃, TmI₃ and TlI (thallium iodide), while Hg or Zn or ZnI₃ can be used as a voltage-gradient generator or buffer gas.

Some of these metal halides normally migrate to the colder regions of the discharge vessel 1 and in particular to the mouth regions of the feedthroughs 8, 9 and the regions of wall surrounding them, condense there and form a deposit 20, which may result in the degradation of lamp performance described above and in damage to the lamp.

To prevent this from happening, there is also introduced into the discharge chamber 11 a metal which is substantially liquid, or in other words is present as a molten phase, at the normal temperatures of the said colder regions and particularly the regions of the feedthroughs 8, 9. This metal is added in a quantity that is sufficient to coat those regions of the feedthroughs and/or walls that are at risk from the deposit of metal halides (which regions may be referred to in general as the temperature sinks), i.e. particularly the space between the electrodes and the inner walls of the feedthroughs 8, 9, and the adjacent regions of the wall 12 of the discharge vessel 1. Any hair-cracks that may exist in the wall 12 of the discharge vessel 1 and that of the feedthroughs 8, 9 are also plugged in this case.

A particularly good way of causing the liquid metal to be transported to these regions is to set up an appropriate temperature gradient within the lamp before the lamp is put into operation for the first time and, if required, at given intervals of time, so that said regions are at a lower temperature and the liquid metal migrates to these regions and lines them.

A suitable temperature gradient may for example be set up by heating the lamp, in the switched-off state, from the outside in the region of the discharge vessel 1 and/or cooling it from the outside in the region of the feedthroughs 8, 9.

Metals that are suitable for this purpose are, for example, aluminum, zinc, tin, bismuth and indium.

This achieves in particular that the metal entirely covers those regions of the electrodes at which the electrodes enter the discharge vessel 1 (the roots of the electrodes), i.e. the regions at which the feedthroughs 8, 9 open into the discharge vessel 1, which regions are sealed with fused glass.

The advantages achieved in this way are, amongst others, the following:

The covering of the roots of the electrodes also substantially reduces, or stops, the transport of tungsten from the electrodes, which may reach critical levels at the high temperatures that are usual, thereby improving the lumen maintenance of the lamp and largely preventing the wall 12 of the discharge vessel 1 from being darkened.

The fact of the fused glass being covered by the metal prevents chemical interactions between the metal halides in the gas filling and the fused glass. Exchange reactions between the metal halides and rare-earth-containing ingredients of the fused glass, which may cause increased corrosion of the fused glass and considerable fluctuations and shifts in the color properties of the light emitted, are avoided.

The metals that are introduced also prevent the metal halides contained in the gas filling from being transported chemically as a result of the temperature gradient from hot to cold.

The result of this is, on the one hand, that the dosage of the (corrosive) metal halides in the gas filling can be greatly reduced because they are not lost while the lamp is operated as a result of their migrating to the colder regions and condensing there. This is thus another way in which the chemical interactions with the metal halides can be reduced to a corresponding degree.

Because, on the other hand, the composition of the molten metal halide phase remains largely constant over the life of the lamp, the color properties of the light emitted are substantially more constant too throughout the whole of the lamp's life.

If suitably chosen, the metal could also perform all or part of the function of the sealing material in the feedthroughs, thus enabling the fused glass to be at least partly dispensed with.

In the case of discharge lamps whose walls are made of quartz glass, the use of the metal mentioned provides the additional advantage that what are called shrink holes, that occasionally form during the fusing of the quartz to produce a seal and are a frequent cause of the premature failure of lamps, can also be plugged.

1. A high-pressure gas discharge lamp having a discharge vessel (1) containing a metal that is applied at least to parts of those regions of the feedthroughs and/or walls of the discharge vessel (1) at which condensation of ingredients of the gas filling may occur due, in particular, to temperature sinks that occur when the lamp is in a state of operation.

2. A high-pressure gas discharge lamp as claimed in claim 1, wherein the metal has a substantially molten phase in the temperature range of the temperature sink.

3. A high-pressure gas discharge lamp as claimed in claim 1, wherein the metal is applied at least to parts of the regions between a feedthrough (8; 9) and an electrode supported therein.

4. A high-pressure gas discharge lamp as claimed in claim 1, wherein the metal is applied at least to parts of those regions (2, 3) of the electrodes at which the electrodes enter the discharge vessel (1) (the roots of the electrodes).

5. A high-pressure gas discharge lamp as claimed in claim 3, wherein the electrodes are positioned in the feedthroughs (8, 9) with fused glass, the metal covering the fused glass in this case.

6. A-pressure gas discharge lamp as claimed in claim 3, wherein the electrodes are positioned in the feedthroughs (8, 9) so as to be sealed by means of the metal.

7. A high-pressure gas discharge lamp as claimed in claim 1, wherein the metal is applied to regions of the feedthroughs and/or walls in which shrink holes are situated, to plug the latter.

8. A high-pressure gas discharge lamp as claimed in claim 1, wherein the metal comprises one or more materials from the following group: aluminum, zinc, tin, bismuth and indium.

9. A method of applying a metal having a substantially molten phase in the temperature range of a temperature sink to, at least, parts of regions of feedthroughs or walls of a high-pressure gas discharge lamp, at which parts of regions condensation of ingredients of a gas filling of a discharge vessel (1) of the high-pressure gas discharge lamp, may occur due, in particular, to temperature sinks that occur when the lamp is in a state of operation, wherein the method comprises at least the step of producing at least one temperature sink in at least one of said regions by heating and/or cooling the lamp from the outside, during which the lamp is not in operation.
